(19) United States
(12) Patent Application Publication
(10) Pub. No.: US 2021/0092121 A1
(43) Pub. Date: Mar. 25, 2021

(54) GRANT AND PROJECT MANAGEMENT AND ADMINISTRATION SYSTEM AND METHODS

(71) Applicant: Blais & Associates, Inc., Little Elm, TX (US)

(72) Inventors: DESTIN BLAIS, Little Elm, TX (US); NEIL BLAIS, Little Elm, TX (US)

(73) Assignee: Blais & Associates, Inc., Little Elm, TX (US)

(21) Appl. No.: 16/578,171

(22) Filed: Sep. 20, 2019

(51) Int. Cl. H04L 29/06; G06Q 50/18; G06Q 40/00

(52) U.S. Cl. CPC H04L 63/101; H04L 63/104; G06Q 40/12; H04L 63/08; G06Q 50/184

(57) ABSTRACT

Methods and systems for managing grants and projects described herein can provide multiple parties secured remote access to a grant and project management and administration system via an Internet portal. User can be authenticated to access the Internet portal, select grant management and project management modules and select an activity from at least one of: searching for grant funding, applying for grant funding, obtaining grant information, managing grant funding, project management, archived record access, reporting grant progress. Data collected from users can be archived and distributed in common as the data pertains to aspects of the grant management and project management modules. Automatic notifications provided to system users pertain to aspects for which users are involved in at least one of managing a grant or managing a project as conditions set up via the Internet portal require such notification.

### FIELD OF THE INVENTION

The present invention generally relates to the field of automated, multi-user data management systems and methods. More particularly, the present invention relates to automated grant, loan, project, and program management systems and methods. The present invention also relates to a systematic series of processes that enables seamless management of a grant- or loan-funded project or program.

### BACKGROUND

The U.S. Fiscal Year 2019 budget proposed $749 billion in outlays for aid to state and local governments (according to Tracking Federal Awards: USAspending.gov and Other Data Sources). Most of this aid is in the form of formula-based or competitive grants or loans. Global giving by U.S. foundations was $9.3 billion in 2015 (based on most recent data available). Almost 58 percent of foundation dollars are awarded to U.S.-based intermediaries according to Council on Foundations and Foundation Center. When a government agency accepts grants or loan funds to complete a project or program, it disrupts the receiving agency's process. Grants and loans come with rules, schedules, budget constraints, and performance measurements, to name a few. The majority of these rules and regulations would not apply if the agency used non-grant or loan funds.

For almost 20 years before the filing of this application for patent rights, the present inventor has worked with over U.S. government agencies managing grant and loan awards. The efforts vary significantly, ranging from a $40,000 grant to plant trees to a $70 million loan to construct a wastewater treatment facility. Based on these experiences, it became evident that there was a lack of understanding as to what it means to accept and comply with the rules and regulations that accompany acceptance of government or foundation money. Agencies are generally disorganized, lacking institutionalized and systematic processes to track and manage both a grant/loan award and the project or program.

The overall reality of post-award grant and loan management is that government agencies can be disorganized when it comes to tracking their grant awards. Project managers are working in isolation of the grant manager and vice versa. There is a true lack of understanding as to what it means to accept a grant award. Management and administration of grant and loan funding is often an after-thought and only given attention after a negative audit. The following are some of the problems with current grant/loan practices: project managers are working in isolation of the grant/loan manager and vice versa, roles that each team member is playing are not clearly articulated, funding agreement are not carefully read, schedules get delayed, reports are filed late, funds sit in limbo year-after-year waiting to be drawn down, audits get scheduled for which no one is prepared, project team members come and go and the relearning starts over again, documents are stored in a myriad of places (if stored at all), specific agency forms and templates become misplaced or lost, and everyone is exhausted when the grant- or loan-funded project or program is finally completed, the funds are all drawn down, and the agreement is closed out.

The manual process of grant management and administration becomes inefficient and unsustainable, especially with funding growth. To that end, the inventor searched the market for a grant/loan administration and project management Cloud-based solution that could be used. All systems were inferior to the systematic (albeit) manual process developed by the inventor. Existing systems focus almost exclusively on the financial aspects of grant/loan management (quarterly reports, filing request for reimbursements, etc.) with no mechanism to track the project, rules, regulations, metrics, schedules, notes, and several other elements necessary for the proper administration and management of funding and projects funded by grants.

What are needed are systems and methods that enable project managers and grant managers the ability to share information seamlessly and work together—not at odds with each other. A system has not been found that resolves both the simple and complex problems associated with managing a project that has been funded with agency funding, such as grants and loans.

### BRIEF SUMMARY OF EMBODIMENTS

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

An improved environment is needed in the grant/loan management industry and the present inventor sets forth systems and methods that automate the unique and systematic manual process enabling multiple parties to manage their respective elements using an online portal/solution. The present inventor has developed a unique and systematic process that incorporates both grant management and project management for the agreement's period of performance and beyond, from initial receipt of funding through records retention. The inventor's effort has resulted in a remotely accessible database system that can be refereed to as “Blais Grant and Project Management Solutions” (BGAPS), which enables multiple users to track and manage grant and loan awards.

Embodiments of the invention were developed to enable government agencies (e.g., cities, counties, and other local government agencies like water districts, fire districts, etc.) to access a single portal that meets the needs of all team members, not just the finance staff. Such a system can enable project managers to manage their project while also complying with the complex and myriad rules and regulations that come with a grant award. The present system and methods can enable grant managers to track key deadlines, record reimbursements, and keep track of the project schedule. Finance managers can use the system to reconcile their traditional accounting software system with the data in the presently disclosed system.

It is a feature of the invention to provide a one-stop solution for both the grant manager and the project manager. Everyone involved can use the same portal to track all things needed to successfully manage a grant and its associated project.

It is another feature of the invention to provide a portal wherein document storage issues can be resolved. All documents can be uploaded and stored in their respective sections. This can include the grant application, grant agreement, bid specifications, bid tabs, contractor agreements, change orders, quarterly reports, requests for reimbursements, etc.

It is also feature of the present invention to provide a systematic series of processes that can enables seamless management of a grant- or loan-funded project or program that would otherwise disrupt the environment and potentially result in the return of grant or loan funds due to noncompliance.

In accordance with features of an embodiment, a method for managing grants and projects can be provided that includes steps of providing multiple party secured remote access to a grant and project management and administration system via an Internet portal; authenticating user authorization to access the Internet portal; enabling user to select grant management and project management modules and select an activity from at least one of: searching for grant funding, applying for grant funding, obtaining grant information, managing grant funding, project management, archived record access, reporting grant progress; collecting data from users, archiving data and distributing data in common as the data pertains to aspects of the grant management and project management modules; and providing automatic notifications to system users pertaining to aspects for which users are involved in at least one of managing a grant or managing a project as conditions set up via the Internet portal require such notification.

In accordance with features of another embodiment, a method for managing grants and projects can be provided that includes steps of providing a grant and project management and administration system enabling authenticated multiple party secured remote access to users via an Internet portal and including a dashboard module, a grant management module, a project management module, and a database storing documents and information related to grants, projects, users, and budgets; accessing the dashboard module via the Internet portal and assigning user roles and user names to at least one of a grant award and a project and authorizing user access to the grant and project management and administration system and data associated with the at least one of a grant award and a project based on a determined level of need for access by authorized users; accessing the grant module via the Internet portal and entering unique information necessary to manage at least one of a grant, said unique information including at least one of: source of funds by name and identification number; performance period with set parameters to enable verification checks to assure scheduled tasks remain within the performance period; final close out date; extensions; pre-award authority identification; audit history; record retention period information; and accessing the project management module via the Internet portal and entering unique information necessary to manage a project associated with the grant, said unique information including at least one of: project name, project location, an identification of team members assigned to the project; project tasks, scheduling, deadlines. Information entered in the dashboard module, the grant module and the project management module can be stored in the database for ongoing access by the authorized users.

In accordance with features of yet another embodiment, a system for managing grants and project can be provided. The system can include a grant and project management and administration system enabling authenticated multiple party secured remote access to users via an Internet portal. The system can further include a dashboard module, a grant/loan management module, a project management module, and a database storing documents and information related to grants, projects, users, and budgets.

### BRIEF DESCRIPTION OF THE DRAWINGS

The accompanying drawings, which are incorporated herein and form a part of the specifications, illustrate the present invention and, together with the description, further serve to explain the principles of the invention and to enable a person skilled in the pertinent art to make and use the invention.

FIG. 1 illustrates is an exemplary simplified grant and loan process, in accordance with the embodiments of the invention is described.

FIG. 2 illustrates an exemplary and simplified grant and loan management process diagram, in accordance with features of the embodiments.

FIG. 3 illustrates an exemplary system architecture that can be utilized for implementing embodiments of the present invention.

FIG. 4 illustrates an exemplary layout of modules that can be accessed via the BGAPS system 400, in accordance with features of the embodiments.

FIG. 5 illustrates a flow diagram illustrating an exemplary grant and project management method, in accordance with features of the embodiments.

FIG. 6 illustrates another flow diagram illustrating an exemplary grant and project management method, in accordance with features of the embodiments.

FIG. 7 illustrates another flow diagram illustrating an exemplary grant and project management method, in accordance with features of the embodiments.

FIG. 8 illustrates an exemplary screenshot of a Dashboard page that can be accessed by a user, in accordance with features of the embodiments.

FIGS. 9A-D illustrates an exemplary screenshots of Project pages that can be accessed by a user, in accordance with features of the embodiments.

### DETAILED DESCRIPTION

The particular values and configurations discussed in these non-limiting examples can be varied and are cited merely to illustrate one or more embodiments and are not intended to limit the scope thereof.

Subject matter will now be described more fully herein after with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems/devices. Accordingly, embodiments may, for example, take the form of hardware, software, firmware or any combination thereof (other than software per se). The following detailed description is therefore not intended to be interpreted in a limiting sense.

Throughout the specification and claims, terms may have nuanced meanings suggested or implied in context beyond an explicitly stated meaning. Likewise, phrases such as “in one embodiment” or “in an example embodiment” and variations thereof as utilized herein do not necessarily refer to the same embodiment and the phrase “in another embodiment” or “in another example embodiment” and variations thereof as utilized herein may or may not necessarily refer to a different embodiment. It is intended, for example, that claimed subject matter include combinations of example embodiments in whole or in part.

In general, terminology may be understood, at least in part, from usage in context. For example, terms, such as “and”, “or”, or “and/or” as used herein may include a variety of meanings that may depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms such as “a”, “an”, or “the”, again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context. Additionally, the term “step” can be utilized interchangeably with “instruction” or “operation”.

Unless defined otherwise, all technical and scientific terms used herein have the same meanings as commonly understood by one of ordinary skill in the art. As used in this document, the term “comprising” means “including, but not limited to.”

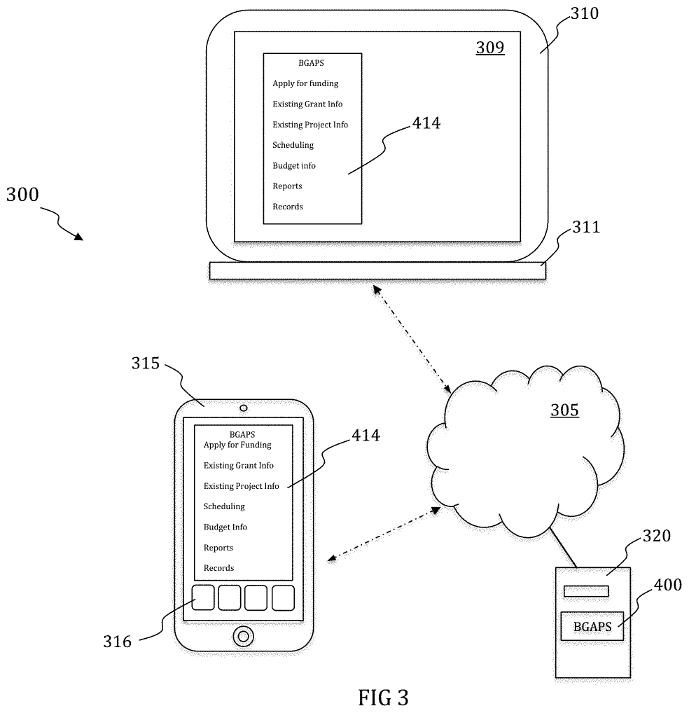

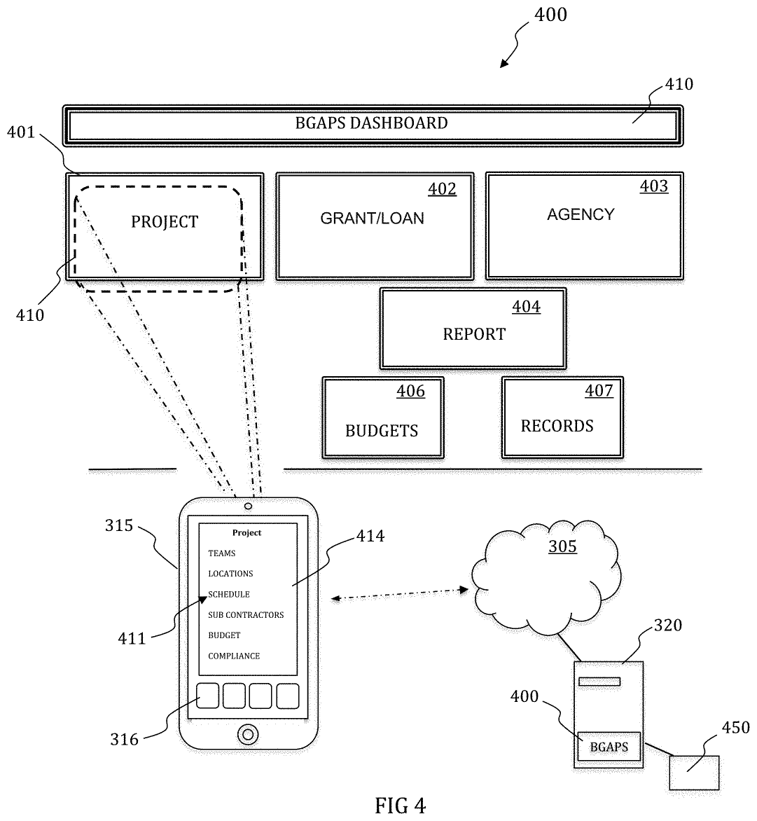

A “computing device” or “electronic device” or “data processing system” refers to a device or system that includes a processor and non-transitory, computer-readable memory. The memory may contain programming instructions that, when executed by the processor, cause the computing device to perform one or more operations according to the programming instructions. As used in this description, a “computing device” or “electronic device” may be a single device, or any number of devices having one or more processors that communicate with each other and share data and/or instructions. Examples of computing devices or electronic devices include, without limitation, personal computers, servers, mainframes, gaming systems, televisions, and portable electronic devices such as smartphones, personal digital assistants, cameras, tablet computers, laptop computers, media players and the like. Various elements of an example of a computing device or processor are described below in reference to FIGS. 3-4.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

FIGS. 3-4 are provided as exemplary diagrams of data-processing environments in which embodiments of the present invention may be implemented. It should be appreciated that FIGS. 3-4 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

The present invention will now be described with reference to the accompanying drawings. In the drawings, like reference numbers indicate identical or functionally similar elements. Additionally, the left-most digit of a reference number identifies the drawing in which the reference number first appears.

A remotely accessible system (i.e., remote server or “Cloud-based”) for grant and project management will be described that enables all parties responsible for managing a grant-funded project or program to use a common portal, and which incorporates unique processes enabling successful grant compliance. An embodiment of the invention includes a Cloud-based application server that allows users that have been pre-assigned a login and password the ability to enter, actively manage, and retain both grant- and project/program-related information, tasks, and documents in order to comply with various government- and foundation-funded grant awards and/or loan proceeds. The application supports all parties responsible for any aspect of the grant, project, or program including project managers, grant managers, fiscal officers, compliance managers, and auditing staff, for example. The following provides specific details.

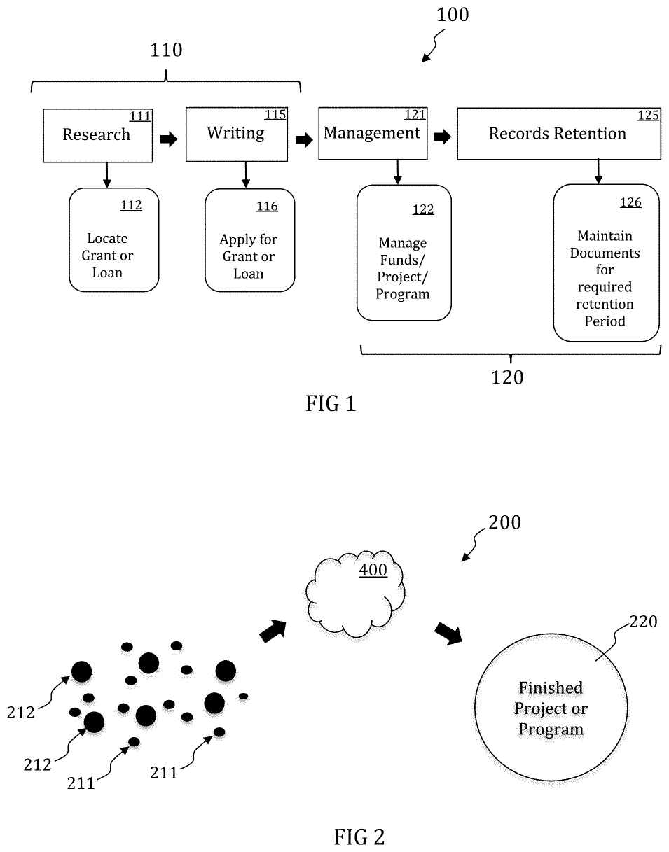

Before providing details regarding the embodiments of the application, a brief description of the general grant and loan environment that would be processed in accordance with the embodiments of the invention is described. Referring to FIG. 1, illustrated is an exemplary simplified grant and loan process 100. The grant/loan process 100 has two distinct phases, pre-award phase 110 and post-award phase 120. Research 111 of grants is the first step in the process pre-award phase 110 of the grant process 100, and generally entails the process of locating a grant or loan that is a viable fit for said project or program. Once a grant/loan is identified, a technician must develop (write) the proposal content, which is identified as the writing 115 step in the pre-award phase 110, and then apply for grant/loan funding 116 by submitting required application materials. The funding agency will review the proposal once it is submitted for consideration and issue a denial or award. When funding is awarded a funding agreement is executed and a Notice to Proceed (NTP) is provided to the awardee. It is at this stage that focused and deliberate management must be applied, as shown in block 121 of the post-award phase 120. Several parties representing the awardee will then manage the awarded funds, project and program as shown in block 122. When the project or program has been completed and the agreement is closed out, the awardee has a records retention obligation 125. The awardee must then maintain records for a specified period of time as shown in block 126, typically at least three years and some as long as 50 years, as part of the awardee's post-award phase 120 obligations.

FIG. 2 provides an exemplary simplified grant and loan management process diagram 200. When a funding agreement is executed, there are multiple parties 211 and multiple tasks 212 that must be managed in order to achieve a successful outcome and not risk having to return the awarded funds. The diagram 200 illustrates the multiple number of people 211 as small dots that can be involved in managing a project or program represented by large dots and is a representative example of the process and how the present invention can organize the complex and disorganized environment that can occur if a systematic and deliberate process is not institutionalized at the beginning of the process. For example, a U.S. Department of Transportation Federal Transit Administration (FTA) grant award may require the assistance of the following personnel at various stages of the performance period: project manager, grant manager, finance officer, procurement manager, design contractor, Buy America compliance manager, prevailing wage compliance manager, construction manager, bus manufacturer, construction contractor, inspector, and auditor. Each party providing assistance must comply with multiple rules and regulations and help ensure compliance for their area of expertise, eventually resulting in a successful, completed project or program 220. Embodiments of the present invention will enable user access to a grant and project management and administration system 400 that can assist in the effective completion of projects 220 and full use of awarded funding upon project closeout.

FIG. 3 illustrates the system architecture 300 that can be utilized for implementing embodiments of the present invention. Users can input and manage data via access to a grant and project management and administration system 400 (hereinafter also referred to as “BGAPS system”) using a variety of input devices including computers 310 (e.g., desktop and laptop computers) and mobile devices 315 (e.g., tablet devices and smartphones). These devices are connected either wired or wirelessly over data networks 305 and via the World Wide Web where users can remotely access and log into the BGAPS system 400 using login and password protocols for authentication. The BGAPS system 400 can be referred to as Cloud-based and can be accessed from any location or device where World Wide Web access is available. In its most simplistic form, the BGAPS system 400 platform provides software routines, a database for data access and storage (both data and document storage), and data computations as needed for financial, budgetary and scheduling needs of its users. BGAPS system 400 functionality that can be provided by servers 320. The BGAPS System 400 can also provide alerts, reports, documents, and analytics based on inputted data via the user's device or printers. Users can access the BGAPS system 400 via a portal 414. The portal 414 presents categories related to grant/loan/project administration and management activities. For example, the portal 414 displayed on the mobile device 315 and computer 310 provides a user with access to modules such as: “Apply for Funding”, “Existing Grant Info”, “Existing Project Info”, “Scheduling”, “Budget Info”, “Reports”, “Records”. Accessing any of these modules will enable a user to operate within the category to conduct management and administration activities (e.g., obtaining scheduling information about a project, accessing records for reporting purposes, checking on a grant balance or project budget). When navigating the portal 414 on a computer 310, users can access module functionality via a keyboard 311. When navigating the portal 414 on a mobile device 315 such as a smartphone or tablet, users can generally access module functionality via soft buttons represented on a touch sensitive display screen 316.

FIG. 4 illustrates an exemplary layout 400 of modules that can be accessed via the BGAPS system 400. Module applications can be completely integrated with data and logically organized and transferred as applicable throughout a system to improve efficiency and reduce errors. The system can be described in more detail as inter-related modules, which can include: a dashboard module 410, an agency module 403, a grant/loan module 402, a project module 401, and a report module 404. Other modules can be provided in the form of information stored in a database 450, which can be the case for information regarding budgets 406 and records 407. Modules and data can interoperate in order to fulfill a user data information request or the reporting of new information from/to the BGAPS system 400 by users via a user device 315.

The described BGAPS system 400 is merely exemplary and could include other features and configurations not shown. FIG. 4 is not intended to be limiting outside the scope of the appended claims. Indeed, one skilled in the art will recognize the numerous different features and combinations that could be employed without departing from the scope and spirit of the claims.

The following sections illustrate in more detail the five basic functional modules included in the application (i.e., the dashboard module, agency module, grant module, project module, and the report module).

FUNCTIONAL MODULE 1: DASHBOARD. A system administrator who assigns user roles and user names can authorize user access to the BGAPS System 400 based on level of need for access. An assignment can generate an automated electronic mail to the new user(s) directing user(s) to the BGAPS system's URL via the World Wide Web. First-time users can be prompted to create and enter their own password. Returning users can be prompted to enter their assigned login name and password in order to regain access to the BGAPS system 400.

There are multiple user roles that can be assigned based on need and authorization. Examples include full access, data entry access, generate reports only, view only, etc. Upon access into the system, the user's homepage is a Dashboard. The Dashboard can enable a user to immediately view their entire grant, loan, project, or program portfolio via various outputs. The output can include, inter alia: a summary of grants or loans by five different categories. Grants can be flagged in the system using five (5) pre-set statuses:
Active, Pre-Award
Active, In Progress
Active, In Closeout
Inactive, Returned
Closed Completed.

The output can include a comprehensive table listing each grant, loan, project, or program in tabular format (columns and rows) with the following column headings:
1. Total Value of Grants in the System
2. Total Grant or Loan Award
3. Local Match, In-Kind, Other
4. Total Project Amount
5. Available Budget
6. Approved Budget

The output can include the total number of grants and loans in the system (raw count), the cumulative total grant and loan award amount, the cumulative local match contributions being made to the grant awards or loans, how much in grant funding is still available for drawdown from all funding agencies, and the overall approved budgets for all grants within the system.

Users can filter all columns in the Dashboard to just a single department within their agency and the grants, loans, projects, and programs managed, can view by a date range, and can click on a specific grant award and immediately be taken to that grant and project within the BGAPS system.

The Dashboard can also display, in GRID format, the value of grants and expiring grants. Users can click on these grids and a pop up provides more information about the particular grant that was selected.

FUNCTIONAL MODULE 2: AGENCY. From the Dashboard, users can be directed to an Agency tab to enter unique organization information that becomes a central repository for basic information needed by all users. This tab can collect unique information that is necessary to efficiently manage grant and loan funds. There can be four sub tabs within the Agency Tab: 1) Client, 2) Department, 3) Contact, and 4) Document Library. Exemplary client information is illustrated in Table 1.

TABLE 1

| Field | Description |
|---|---|
| Client Name | Enter name of agency |
| | with license to use |
| | BGAPS |
| Primary Phone | Enter primary phone |
| | number for agency |
| | primary contact |
| Secondary | Enter secondary phone |
| Phone | number for agency |
| | primary contact |
| Fax No. | Enter the agency's |
| | facsimile number |
| Website Info | Enter website URL |
| Logo Upload | Upload agency's |
| | primary logo, which is |
| | then used to populate |
| | reports |
| Physical Address | Enter the primary |
| | physical address for |
| | agency including |
| | address, city, state, and |
| | zip code |
| Mailing Address | Enter the agency's |
| | mailing address if |
| | different than physical |
| | address |
| Number of Seats | Enter the number of |
| | seats authorized for |
| | subscriber |
| Contract Signed- | Enter software license |
| Expiration Date | beginning and end dates |
| Federal Tax ID # | Enter the agency's Tax |
| | Identification Number |
| | assigned by the Internal |
| | Revenue Service |
| DUNS # | Enter the agency's |
| | primary Dun and |
| | Bradstreet number (use |
| | notes section for |
| | additional DUN |
| | numbers, if applicable |
| DUNS | Enter description for |
| Description | DUNS number |
| Fiscal Year | Enter the last month and |
| | day of the agency's |
| | fiscal calendar |
| FIPS Number | Enter the U.S. Federal |
| | Information Processing |
| | Standard Publication |
| | Number for organization |
| SAM Account | Enter information about |
| Number | agency's SAM account |
| SAM Expiration | Enter date the agency's |
| | SAM account expires |
| Client Notes | Enter important |
| | information about client |
| | or agency |
| Grants.gov info | Enter log-in credentials |
| | and expiration date(s) |
| | for grants.gov online |
| | portal |

After entering appropriate data for the Client sub-module, users can be directed to enter the names of departments at the agency or organization and identify if the department is active or inactive within the system. Active status indicates the department has, or will have, projects to manage within the system. This sub-module can create drop-down menus for other fields within the system.

The next sub-module is Contact, whereby users enter contact information for agency member. This sub-tab can collect the first and last name, telephone number, email address, title within the agency, and department. This sub-tab creates drop-down menus for other fields within the system.

The next sub-module is a Document Library, whereby users can be directed to upload documents that pertain to the overall client organization. These documents can be stored within the system, organized by pre-set categories, and displayed in a grid for easy retrieval. Users can tag each document for inclusion in the audit tab.

FUNCTIONAL MODULE 3: GRANT. The Grant module can include three (3) sub-modules that can enable users to input critical information about a grant or loan award.

Grant General Sub-module. The General Grant tab collects the information presented in Table 2 and can incorporate loan proceeds. Users enter information one time affording all additional users access to this basic, yet critical data, which is needed multiple times throughout a funding agreement's performance period. Exemplary grant information is illustrated in Table 2.

TABLE 2

| Field | Description |
|---|---|
| Status | Select status of grant |
| | from list of five options |
| Client | Select from list |
| Department | developed by user in |
| | Functional Module 2 |
| Project Name | Enter project name |
| Department | Select from list |
| | developed by user in |
| | Functional Module 2 |
| Original Funding | Select from list of pre- |
| Source | defined sources |
| Awarding | Select from pre-defined |
| Agency | list based on selection |
| | from Original Funding |
| | Source |
| Department | Select from pre-defined |
| | list based on selection |
| | from Awarding Agency |
| Grant Program | Select from pre-defined |
| Name | list based on selection |
| | from Department |
| Grant Award | Enter dollar amount of |
| | grant or loan award |
| Local Match | Enter the dollar amount |
| | of the local match |
| Required | Enter the minimum local |
| Minimum Cost | match percent or dollar |
| Share | value |
| Performance | Enter start date and end |
| Period | date for time period all |
| | work must be completed |
| Grant Award | Enter the date the grant |
| Date | agreement was fully |
| | executed |
| Grant Final | Enter the date the grant |
| Close Out Date | must be completely |
| | closed out |
| Pre-Award | Identify if the funding |
| Authority | agency has grant pre- |
| | award authority |
| Pre-Award | Enter the date when pre- |
| Authority | award authority begins |
| Effective Date | |
| Scope of Work | Enter scope of work |
| | narrative |
| Notes | Enter special note about |
| | the project or scope of |
| | work |
| Short Description | Enter short project |
| | description |
| Agreement # | Enter agreement |
| | number assigned by |
| | funding agency |
| CFDA | Select from pre-defined |
| | list the federal Catalog of |
| | Federal Domestic |
| | Assistance # if federal |
| | award |
| Grant Program | Select from pre-defined |
| Name | list based on selection |
| | from CFDA |
| Authorized | Enter name, title, email, |
| Signor | and telephone number |
| | of agency's authorized |
| | signor; select from |
| | department name from |
| | list developed by user in |
| | Functional Module 2 |
| Funding Agency | Enter name, title, email, |
| Project Manager | and telephone number |
| Contact | of agency's Project |
| | Manager; select from |
| | department name from |
| | list developed by user in |
| | Functional Module 2 |
| Extension | Identify if extensions to |
| Allowed | the performance period |
| | are allowed |
| Audits | Enter date(s) when prior |
| | audits were conducted |
| | and upload report(s) |
| Records | Enter date when |
| Retention Period | documents can be |
| | destroyed with no |
| | penalty from funding |
| | agency |

Exemplary functions of the Grant General sub-module include the following sub modules:

Catalog of Federal Domestic Assistance Number. During the input process, users can be prompted to identify the original source of the funds (e.g. federal agency, state agency, local foundation, etc.). If federal funding is selected, a secondary dropdown menu can prompt users to select the corresponding Catalog of Federal Domestic Assistance (CFDA) number. The CFDA number is required during an audit that is being conducted for Single Audit purposes (a requirement for any agency receiving over $750,000 in federal funds in a single year).

Performance Period. The performance period can set parameters for the balance of the software system by performing verification checks with the Project Schedule and Project Financial sub-module. If a user attempts to enter a task/milestone that is outside the date of the performance period, the system can alert the user that the task is not within the performance period of the grant. The performance period can also set in motion (send out) a series of email alerts to the identified project manager that the performance period is expiring.

Grant Final Close Out Date. Users can be prompted to enter the final grant closeout date, which can set in motion a series of email alerts that can be sent out to the identified project manager that the close out period is expiring.

Extensions Allowed. Users can be prompted to enter yes/on if extensions to the performance period or grant final close out date are allowed. If yes, users are allowed to enter additional information.

Pre-Award Authority. Users can be prompted to identify if pre-award authority has been authorized. If selected, the system can integrate with the Project Financial sub-module to allow expenses to be entered prior to the performance period start date.

Audits. Users can be prompted to enter the date(s) an audit was conducted and upload the Audit Findings Report.

Records Retention Period. Users can be prompted to enter the date when the Records Retention requirement has expired (i.e., the date files can be destroyed with no penalty from the funding agency).

After entering appropriate data to the Grant General sub-module, users can be directed to two additional sub-modules: 1) Document Library and 2) FAQ. Exemplary elements include:

Document Library sub-module: this sub-module can be identical to the document library sub-module discussed in the Client Module; however, this document library collects grant-specific documents. Users can be directed to upload documents that pertain to the grant. These documents can be stored within the system, organized by pre-set categories, and displayed in a grid for easy retrieval. Users can tag each document for inclusion in the audit tab.

FAQ sub-module: this sub-module can be titled “Frequently Asked Questions” (FAQ) and can allow users a place to “park” frequently asked questions about the grant or loan award. The system can prompt users to enter a question and, when submitted, can prompt the user to enter the corresponding answer.

FUNCTIONAL MODULE 4: PROJECT. The Project module can include sub-modules that can enable users to input critical information about a project or program and effectively manage the project or program throughout the performance period. The eleven sub-modules can include:
1. General
2. Project Team
3. Financials
4. Project Schedule
5. Compliance Checklist
6. Reports
7. FAQ
8. Document Library
9. Notes
10. Metrics
11. Audit

Project Team Sub-module: Identification of team members assigned to a grant, loan, project, or program, and key staff information (email, phone, address, role in program) is oftentimes kept in Microsoft Outlook or a spreadsheet. Each person associated with the grant, project, or program can keep their own separate database of team members. If a new grant is awarded and a similar team is being compiled for the new award, the same team members have to be manually entered into some sort of system.

Exemplary project team information is illustrated in Table 3.

TABLE 3

| Field | Description |
|---|---|
| Grant Award # | Enter grant award # |
| | assigned by funding |
| | agency |
| Contact Info | Enter funding agency |
| | contact information |
| CFDA | Select the federal |
| | Catalog of Federal |
| | Domestic Assistance # |
| | if federal award |
| Performance | Enter start date and end |
| Period | date for time period all |
| | work must be |
| | completed |
| Extension | Identify if extensions to |
| Allowed | the performance period |
| | are allowed |
| Amount of | Enter dollar amount of |
| Funding | grant or loan award |
| Local Match | Enter the dollar amount |
| | of the local match |
| Match Percent | Enter what the minimum |
| | local match percent or |
| | dollar value must be |
| Pre-Award | Identify if the funding |
| Authority | agency has grant pre- |
| | award authority |
| Close-out Date | Enter date when |
| | funding agreement must |
| | be closed out |

An exemplary functions of the Grant Project Team sub-module can include: a copy feature wherein users can copy project teams from other grants entered in the system to the current sub-tab for a new grant/project.

Assignment of Team Members to Compliance Checklist and Project Schedule. Team members entered in the Project Team sub-module can be the basis for drop down menus in other sub-modules and allow users to select personnel to be responsible for compliance tasks or project schedules. The email addresses entered in the Project Team sub-module can be linked to the Compliance Checklist and receive auto-generated email alerts when certain deadline parameters are established by the system.

Without these improvements, the manual entry of team member information is a huge waste of time as contact information and the role each team member is playing is not clearly articulated, in writing. This manual operation or entry into separate systems is also not transferable to other documents like a schedule or compliance task list.

Financials—Tracking Grant Dollars and Local Matching funds. There are several problems associated with finance when it comes to grant/loan management. Most funding agencies have specific forms and templates that must be used to request a reimbursement of funds from them. Sometimes these forms are readily available and sometimes the grant manager/program manager must search for them or obtain them from the funding agency. Once the forms and templates are obtained, they are oftentimes placed in file system where only one person has access to them. If that person moves to a new assignment, is absent when the task is due, or leaves the agency, the knowledge about these forms and templates is lost, which is a problem. Furthermore, as reimbursement requests are processed, the backup documents for each request are oftentimes stored on a single system and not organized or collated into one complete package for long-term records retention.

Tracking the local match is oftentimes done “offline” using a different spreadsheet and tracking mechanism. Also, if more than one local match funding source is being contributed to the project (e.g. the project is being funded by 1) grant funds, 2) General Revenue funds, 3) Local Gas Tax Funds, and 4) another grant from a different funding agency), the grant manager will likely have four separate spreadsheets to track all of these different funding sources for the same project. This creates a huge burden for the grant manager.

As for the provision of reimbursements (e.g. a check or direct deposit to recipients/claimants), the finance department typically receives the check or electronic transfer of funds and does not let the grant manager or project manager know, nor is there a reconciliation of what we requested vs. what the funding agency may have provided. Many times, the funding agency will disallow a cost and reduce the reimbursement. Or the funding agency will hold back a percent of the funds until the project is completed. Because different people within the entire organization are involved in the handling of funds (this is a requirement from a proper accounting perspective) lack of communication and tracking of funds is very problematic for agencies when a project is funded using grant funds. For example, the project manager (the staff person responsible for building the new park or the social worker responsible for implementing a juvenile recidivism program) are collecting invoices from contractors, reviewing them for accuracy, approving them and then sending them to the grant manager for processing. The grant manager will review the invoices and timecards, etc. and approve and complete the forms and templates to request a reimbursement from the funding agency. The check or direct deposit will be received at the finance department. The finance staff member will then deposit the check.

It is also very common for the original, approved project budget to be amended during the life of the grant/project. Sometimes more grant funding is needed, and the funding agency will add additional funds to the award amount. Other times, changes within line items is necessary as true costs are now being known more clearly. Some funding agencies require that they approve individual line item adjustments if it exceeds a certain percent (e.g. 10% or more). If a budget amendment is processed and approved by the funding agency this entire process and conclusion needs to be documented and the adjustments made within the tracking system being used. Again, communication between the myriad staff members who are involved in the financial aspect of the grant award need to be included in any budget amendment approvals, etc., thereby complicating the process of obtaining additional funding.

An approved budget typically comes with caps per line items. For example, if design funds are provided for a construction project, the grant funds will only pay for up to 15% of the total construction cost for design. There are multiple other caps or funding restrictions a funding agency will place on specific line items. Tracking these caps and ensuring that request for reimbursements do not exceed these caps is also problematic. If a funding cap is violated, accounting amendments/adjustments are required, the funding agency must be notified, and a myriad of other manipulations occur that waste staff time and resources.

Any missteps or mistakes in the financial tracking and reimbursement process could result in the funding agency viewing the city/county/agency in a negative light and flag the city/county/agency for being a “high risk” grantee, subject to additional oversight. This of course is a significant problem and could impact the city/county/agency's ability to receive funds from the same funding agency in the future.

The BGAPS System 400 enables users to enter the original, approved budget, track active requests for reimbursements, show a historical tracking of requested and approved amendments, show a historical tracking of requests for reimbursements, confirm funds that are received, track retainage by the funding agency, and provide a summary snapshot of key information. As reimbursement request are processed, the BGAPS System 400 can alert users if a line item request is exceeding a pre-set funding cap or if the entire RfR exceeds the overall grant approved total. The BGAPS System 400 can also allow users to track ALL funds that have been applied to a project or program. The BGAPS system 400 can eliminate the need to keep separate spreadsheets and tracking mechanisms if there is more than one funding source being spent on the same project or program.

All reimbursement requests, forms, temples, and receipt of funds can be copied/scanned into the BGAPS system 400 and uploaded into an appropriate section. For example, for Request for Reimbursement #1, the packet containing the required forms and templates and all back-up materials can be collated into one ADOBE file. This file can be uploaded into the system and an icon can be immediately placed near the RfR #1 entry in the software system. Any user wanting to view the exact documents that were sent to the funding agency can click on the icon and view the submission. When the check is received from the funding agency, it can be scanned into the system and placed via a 2^{nd} icon near the RfR submission documents. If there is a difference between what was requested vs. received—the user can enter the difference in a “Reconciliation” sub tab for reconciliation at the conclusion of the grant period. All of these uploaded documents can be “flagged” for the Audit Binder as well.

The system can also allow users to enter one grant but assign multiple projects to the one grant or vice versa. Users can enter multiple grants awards and assign that grant to one project. The system can automatically track the grant funds across the board when one grant has been assigned to multiple projects and alert the user if the funding amounts are not balanced between the multiple projects.

All Requests for Reimbursement deadlines can be entered into the Schedule and email alerts prompted to remind users that an RfR is due to the funding agency.

Schedule. A problem with grant and project management occurs when nobody keeps a master schedule of important deadlines/due dates and identifies who is responsible for important date-driven tasks. Typically, different people that are responsible for different parts of the grant and project will keep their own respective schedules/timelines and they are not shared with each other. The separate schedules also reduce communication and if they are shared, it can be cumbersome to have to analyze two or three different schedules for the same overall project/program/grant. This can be a huge time waster, as staff must constantly keep referring back to the grant agreement or separate spreadsheets to determine when a task is due, etc.

The Scheduling feature of the present invention is unique in the software project management sector because a Schedule tab 411 (refer to FIG. 4) can be provided that allows anyone involved with the team to input their tasks, assign a person responsible for the task, enter a start date and end date and have the system send an email alert when the deadline is coming due. This includes the grant manager being able to input quarterly report due dates, when a Request for Reimbursement needs to be filed, or when a semi-annual or annual report is due to the funding agency. Alternatively, the project manager can input all his/her tasks and due dates for mobilization, design, engineering, right of way, bidding, construction, demobilization, notice of completion, etc. And again, the wage compliance manager can enter his/her deadlines for going on site to conduct contractor reviews. The BGAPS System 400 also enables users to enter tasks and deadlines as single entries or reoccurring entries. For example, if a quarterly report is due on the 15^{th} of each month, and this activity will take place for three years, the user can enter this is a reoccurring deadline and the system can auto generate the tasks for the next three years (eliminating manual entry of 12 deadlines; 4 reports per year×3 years=12 deadlines).

It is another feature of the present invention to allow for viewing and printing the schedule in two formats: 1) a list format that can be sorted by any field (person responsible, due date, end date, etc., or 2) Gannt format by week month, and year.

The Schedule function can also allow users to enter the actual start date of a task and the completion date. This enables analysis for task completion and where schedule slippage may be occurring. Tasks can be flagged as hard deadline tasks or soft deadline tasks. Hard deadline tasks are deadlines that cannot be changed (for example, when a quarterly report is due to the funding agency). Hard deadlines can also be milestones that if not met, will result in major problems to the overall schedule. Conversely, soft deadlines are tasks that, while they are date sensitive, if the date is missed or needs to change, it does not have to be a detriment to the overall project schedule or there is no penalty for missing the deadline.

If a team member is deleted from the Project Team list (see below), the team member is, by default within the coded system, replaced and any standing email alerts revert to the Project Manager.

Compliance Checklist. It is yet another problem in the field when no one knows what the rules and regulations are for the respective grant and no assignments are made (by name) to ensure compliance. This can be a significant problem as it could at best delay being reimbursed with grant funds and at worst require the City to repay the grant award. Noncompliance is not an issue to be taken lightly and often results in poor audit findings, which can keep the City from receiving future grant awards.

It is a feature of the present invention to include a Compliance Checklist that can be provided as a compilation of major compliance requirements from the grant contract, state laws and regulations, federal laws and regulations, OMB Circulars, Executive Orders, etc. The Compliance Checklist can require the entry of the law/regulation/rule, a place to list the reference or page number (where it is found), special notes, and assigns a person on the team who is responsible for compliance. There can also be a checked box provided to enable a user to confirm that the City/County/Agency has officially complied with said law/regulation/rule. The BGAPS System 400 can also create a table and report all entries and they can be printed to take to meetings and reviewed with all parties. The table can be sorted in a variety of ways including by person responsible, so someone can sort the checklist by their name only, print it, and keep track of their own responsibilities.

Frequently Asked Questions (FAQ). During the life of a grant/project, there begins to be the same questions that people/staff/contractors are constantly asking and for which the same answer must be given over and over again. This wastes staff time when locating the same answer time and time again. To help quickly answer questions that are being asked repeatedly, a FAQ sub tab can be made available for users. Oftentimes users will go to this tab first to find an answer before going o the Compliance Checklist or viewing the grant agreement. The FAQ list can be viewed as an entire report and printed for distribution or email.

Document Control/Library. With different staff and contractors assisting on a project, documents pertaining to the project or program can be housed on different PC/s/MACs/file storage systems. This can also be a time waster as staff will spend hours looking for the same document repeatedly or what is available isn't filed logically, etc. “Hunting” for documents becomes a waste of organizational and personal time. Missing documents simply become an auditing time waster and, in the worst-case scenario, can be a major audit finding. Also, with an unorganized filing system and files on different file sharing systems (or no file sharing system at all), no one may truly know what documents are available or on hand for the project or grant. Missing documents go undetected. The BGAPS System 400 can include a document library and Cloud-based file storage system that comes with pre-set categories. This can enable everyone who is a party to the grant, project, or program to access all files regardless of their location. The Internet and log in credentials are the only things that can be required to upload/download/view documents. Pre-set categories allow users to immediately identify missing documents that should be uploaded. For example, a pre-set category is “Grant Award.” If there are no files uploaded under this category, the user immediately recognizes that the grant award document is not in the system. It needs to be uploaded.

Notes—Tracking Important Notes, Emails, and Phone Calls. People often receive emails or have telephone calls that are important for the project, but this grant- or project-related information is not typically shared or documented for perpetuity. This can be a major problem when multiple staff and contractors are involved in the project or program. This can mean that important information is not relayed or documented for auditing purposes. In the grant industry, much of the information that is relayed is through emails and conference calls with the funding agency. While there are guidelines and the grant agreement that documents rules, process, and regulations, different funding agency staffs have differing opinions on topics and this can affect the management of the grant award and project. If emails or verbal communication is provided that directly impacts the grant or project or if email or verbal guidance contradicts written procedural manuals, etc. this must be documented.

The BGAPS System 400 can include a special tab for recording notes by date and person who entered the information. Emails can be saved as an ADOBE PDF and uploaded in the document library. The system can allow for different levels of log in credentials to enable anyone to go into the Notes section and quickly record a phone conversation or email summary. This same user will not necessarily have access to do anything else in the system though. This creativity in creating different user levels to allow for anyone to enter data into the notes section ensures that anyone, no matter their level of log in credentials, can take ownership in the project and ensure the information they received is communicated and recorded to all other staff involved with the project.

Metrics. Some grant awards are tethered to meeting mandatory metrics or goals and objectives. These are oftentimes considered by the grantee (agency receiving the grant funds) as a low priority to track and report back to the funding agency. However, the funding agency views metrics as a critical element to a grant award and if the metrics or goals are not achieved, the grant funds can be rescinded. The obvious conflict becomes ensuring that agencies are capturing and tracking the required metrics/goals/objectives and reporting progress per the timeframes established by the funding agency. By providing a unique sub tab that allows users to capture mandatory metrics and goals/objectives the BGAPS system 400 can place priority on capturing and monitoring metrics. The metrics sub tab can allow users to enter Metrics Details, thereby keeping a running progress report on meeting the metrics, objectives, additional notes, and challenges. In addition, the user can use the Project Schedule tab to enter and track the metric reporting requirement dates and timeframes, which by entering reporting dates in the Project Schedule triggers automatic email reminders to select project managers. And finally, important documents applicable to metric reporting (reports from consultants in the field, forms and updates provided to the funding agency, etc.) can be uploaded to the Document Library and flagged for the Audit Tab, if applicable.

Audit Tab. Auditor may come on site to audit a grant, project, or program. A list of documents needed to audit is typically presented to project manager, grant manager, or CFO, etc. Everyone typically goes on a frantic search for the documents and it turns into a hunt and peck exercise that causes stress and wastes time. At best, the information and documents are located, printed, collated, and provided to the auditor. At worst, extensions are asked for because more time is needed to prepare for the audit (which looks bad) or documents are never found, and material audit findings are rendered. Preparing for an audit is extremely time consuming for finance staff, and others that have information. In addition, auditors are now asking cities/counties/agencies to send certain documents in advance of an on-site audit. An auditor will send a checklist of documents or procedures they want to review prior to coming on-site. This, again, takes a significant amount of time to find, print, collate, or email in batches due to file saves being extremely large for some documents (e.g. MB size is so large that emails must be sent in batches or a link must be provided).

The BGAPS System 400 can include an Audit Tab that enables users to identify documents that need to be readily available during an audit. This tab can create one-stop access for all documents that have been “tagged” throughout the life of the project or program. For example, when the grant agreement is uploaded to the Document Library, the user identifying the document as a critical document for an audit can check a check mark box. This document is immediately identified in the Audit Tab as readily available and can be downloaded directly from the Audit Tab without having to go through various tabs in the BGAPS system 400. This “audit binder” check box can be provided on any screen/tab within the system where a document or image has been uploaded.

A unique element of the system is that the city/county/agency can assign a temporary log in and password for any 3^{rd} part auditor for access to just the audit tab. Since the software system can be Cloud-based, one only needs access to the Internet to access the software system. The auditor can send a checklist of documents that they need to review and see prior to coming on site. The majority of these documents may have already been flagged as needing to be placed in the audit binder during the routine management of the grant and project/program. If not, the project manager or grant manager can locate the documents in the software system and flag them for the audit binder, which can immediately place that document in the special Audit Tab. When all documents have been flagged and placed in the Audit Tab, a temporary, and time sensitive log in and password can be provided to the 3^{rd} party auditor and he/she can have access to just the Audit tab for a set period of time. Any document identified in the Audit Tab can be viewed or printed. Also, within the General Grant tab, there are two fields that assist users: 1) Audit(s) conducted and 2) Records Retention Period Ends. Within the Audit(s) conducted field, users can upload and have available at this field the audit report/findings.

Records Retention. Every grant award has a mandatory records retention requirement. The retention period is typically three years, but it can be longer (even up to 10 years for some grant programs). This means city/county/agencies are required to maintain a complete set of records for the grant-funded project for several years. As staff members change or move on to other jobs or careers the “knowledge” about what was done can be lost and files and documents can go missing.

Since all documents pertaining to the grant funded project can be uploaded and stored within a single Cloud-based solution provide under the BGAPS System 400, files should no longer “go missing” during the records retention period. Also, the software system can provide a “notes” tab and several other places where special notes can be inserted memorializing what took place at the time. Regardless of staffing changes, the grant-funded project can remain intact with respect to records retention requirements in perpetuity. When the grant is closed out, the user can flag the grant as “Closed Completed.” Also, within the General Grant Tab, there can be provided a field that allows users to enter the date that the agency is released from the records retention requirement.

Functional Module 5: Report. Reports generation is another important feature provided by the BGAPS system 400. Reports are needed for manager evaluation and well as for third parties, such as auditors. The Report module can assemble documents relevant to a particular task requested under the system, e.g., audit documents for grant X, project Y, and the system can pull documents stored in a database or databases in association with the defined search criteria. A report can then be generated in a format requested by the user, where after the report can be reviewed on a computer or printed. The Report Module can interface with other modules (e.g., schedule, metrics, note tab, etc.) to generate a report based on the request.

In light of the foregoing description regarding various modules that can be included in the BGAPS system 400, an overview of methods for managing grants and projects in accordance with some features of the present invention can now be summarized. Referring to the flow diagram 500 in FIG. 5, a method for managing grants and projects is illustrated. Referring to Block 510, multiple party secured remote access to a grant and project management and administration system can be provided via an Internet portal. As shown in Block 520, users can be authenticated to access the Internet portal. Authorized users can then be enabled to select grant management and project management modules and select an activity from at least one of: searching for grant funding, applying for grant funding, obtaining grant information, managing grant funding, project management, archived record access, reporting grant progress as shown in Block 530. Then as shown in Block 540, data collected from users can be archived and distributed in common as the data pertains to aspects of the grant management and project management modules. Finally, as shown in Block 550, automatic notifications can be provided to system users pertaining to aspects for which users are involved in at least one of managing a grant or managing a project as conditions set up via the Internet portal require such notification.

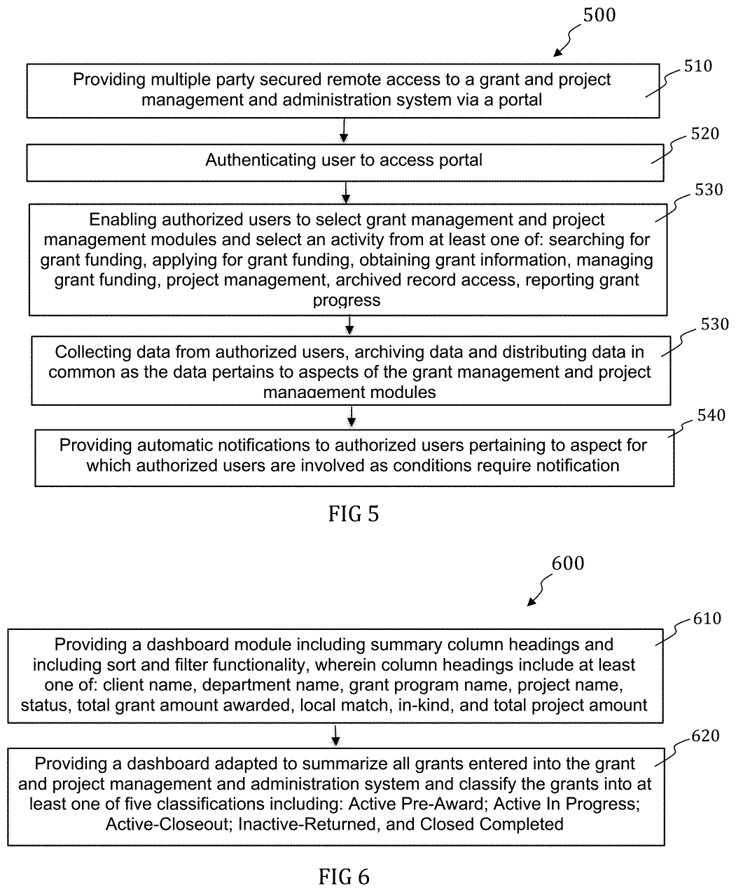

Referring to FIG. 6, a flow diagram in accordance with another feature of the present invention is illustrated. As shown in Block 610, a dashboard module including summary column headings and including sort and filter functionality can be provided, wherein column headings include at least one of: client name, department name, grant program name, project name, status, total grant amount awarded, local match, in-kind, and total project amount. Then, as shown in Block 620, a dashboard adapted to summarize all grants entered into the grant and project management and administration system can be provided to classify the grants into at least one of five classifications including: Active Pre-Award; Active In Progress; Active-Closeout; Inactive-Returned, and Closed Completed.

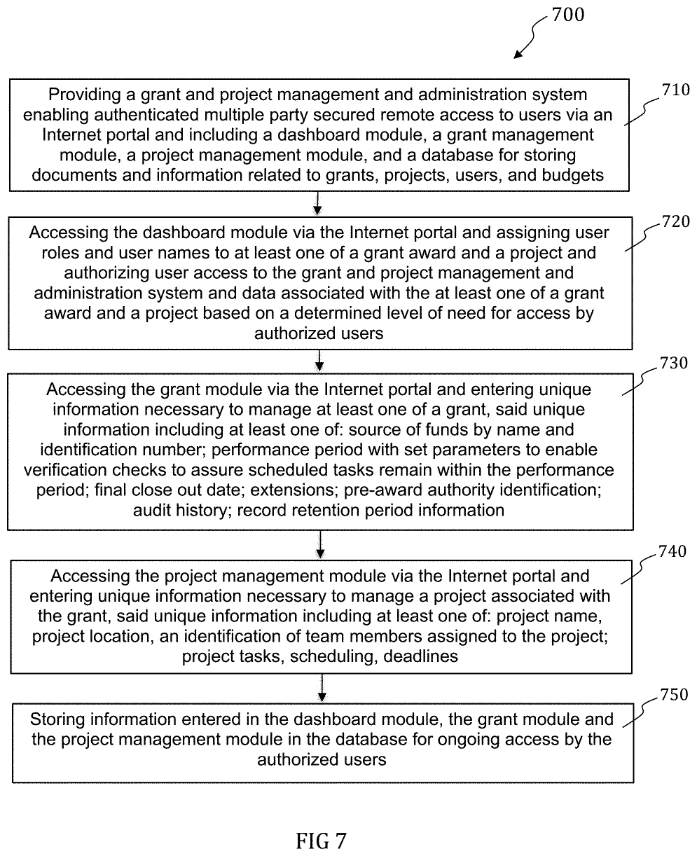

Referring to the flow diagram 700 in FIG. 7, another method for managing grants and projects is illustrated. As shown in Block 710, provided is a grant and project management and administration system enabling authenticated multiple party secured remote access to users via an Internet portal and including a dashboard module, a grant management module, a project management module, and a database storing documents and information related to grants, projects, users, and budgets. As shown in Block 720, the dashboard module can be accessed via the Internet portal and assigning user roles and user names to at least one of a grant award and a project and authorizing user access to the grant and project management and administration system and data associated with the at least one of a grant award and a project based on a determined level of need for access by authorized users. As shown in Block 730, the grant module can be accessed via the Internet portal and entering unique information necessary to manage at least one of a grant, said unique information including at least one of: source of funds by name and identification number; performance period with set parameters to enable verification checks to assure scheduled tasks remain within the performance period; final close out date; extensions; pre-award authority identification; audit history; record retention period information. Then, as shown in Block 740, the project management module can be accessed via the Internet portal and entering unique information necessary to manage a project associated with the grant, said unique information including at least one of: project name, project location, an identification of team members assigned to the project; project tasks, scheduling, deadlines. As shown in Block 750, information entered in the dashboard module, the grant module and the project management module can be stored in the database for ongoing access by authorized users.

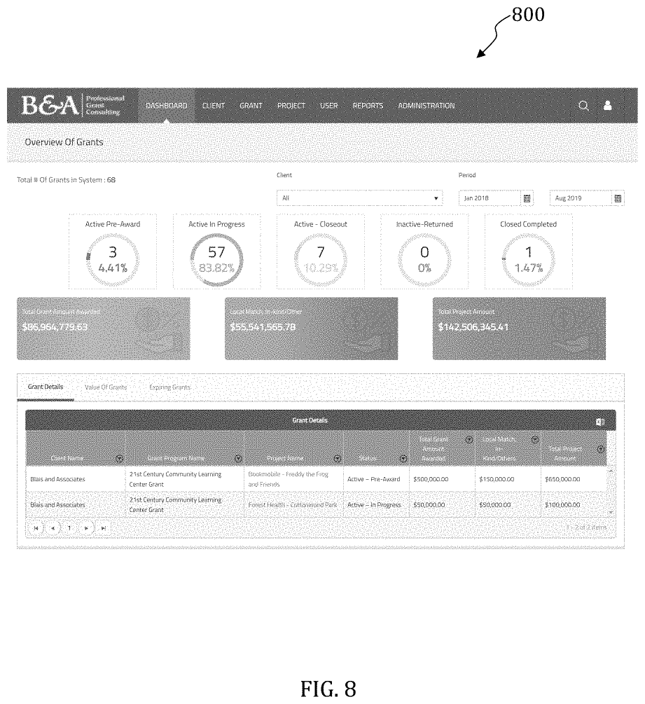

Referring to FIG. 8, illustrated is an exemplary screenshot of a Dashboard page that can be accessed by a user, in accordance with the embodiments. The dashboard 800 can provide an Overview of Grants to users. Information such as, for example, grants that are in pre-award, in progress and closed out can be provided. Amounts of grant funding, matching funding and total funding can also be provided. Users can access other grant details from the Dashboard.

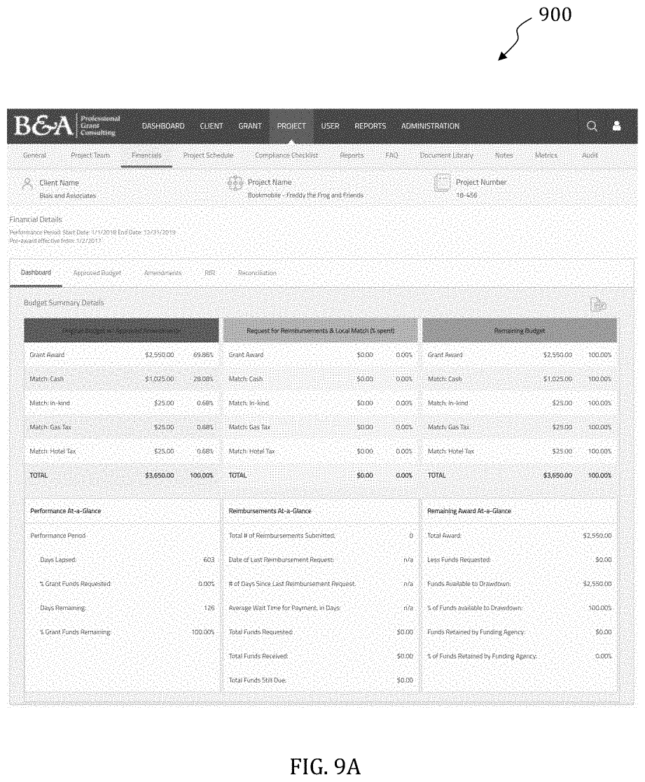

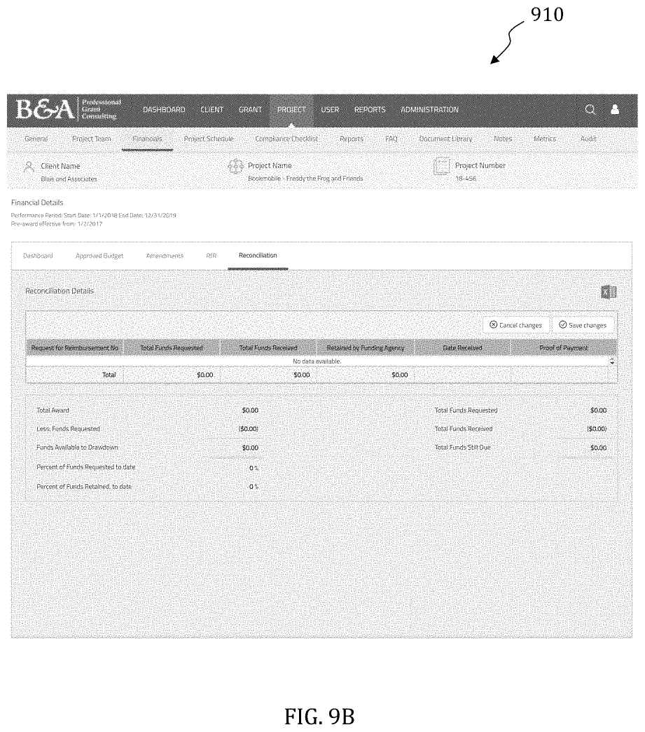

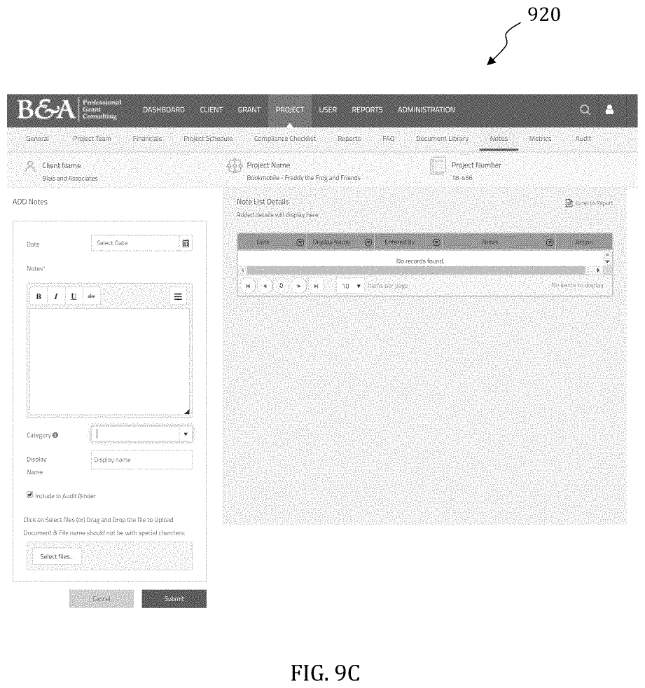

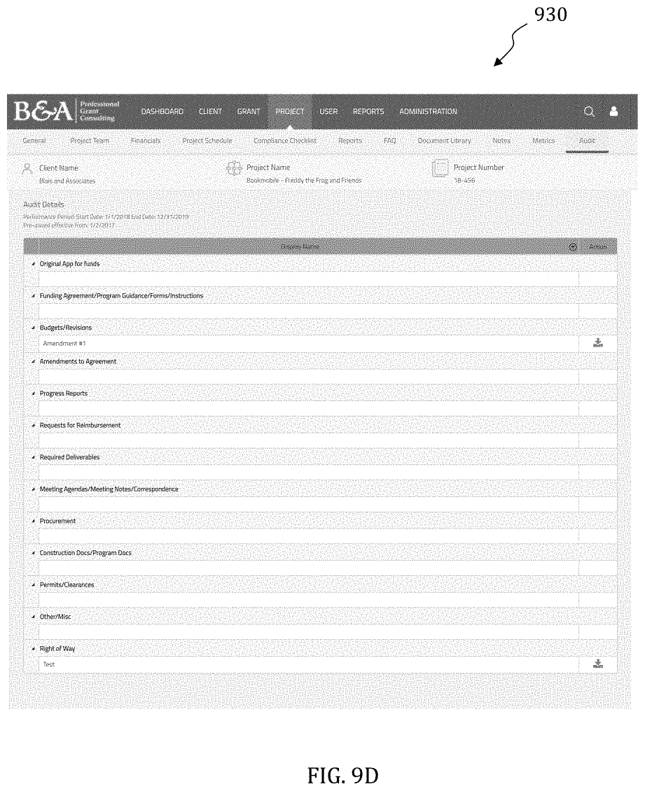

Referring to FIGS. 9A-D, illustrated are exemplary screenshots of Project-related pages that can be accessed by a user, in accordance with the embodiments. FIG. 9A provides an exemplary itemization of budgetary items (e.g., Original Budget, Reimbursement requests, Remaining budget). FIG. 9B provides an example reconciliation schedule. FIG. 9C illustrates an exemplary Notes page wherein project information can be recorded and stored for future reference. FIG. 9D illustrates an exemplary Audit page wherein data relevant to potential audits can be stored, organized and managed and can be provided as a location where authorized third parties (e.g. auditors) can review the data.

It should be appreciated that variations of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the following claims.

What is claimed is:

1. A method for managing grants and projects, comprising:
providing multiple party secured remote access to a grant and project management and administration system via an Internet portal;
authenticating user authorization to access the Internet portal;
enabling user to select grant management and project management modules and select an activity from at least one of: searching for grant funding, applying for grant funding, obtaining grant information, managing grant funding, project management, archived record access, reporting grant progress;
collecting data from users, archiving data and distributing data in common as the data pertains to aspects of the grant management and project management modules; and
providing automatic notifications to system users pertaining to aspects for which users are involved in at least one of managing a grant or managing a project as conditions set up via the Internet portal require such notification.

2. The method of claim 1, wherein the grant and project management and administration system enables authenticated users responsible for any element of a grant-funded project or program via a single system to manage an entire life cycle of the grant-funded project or program.

3. The method of claim 1, further comprising providing a dashboard adapted to summarize all grants entered into the grant and project management and administration system and classify the grants into at least one of five classifications including: Active Pre-Award; Active In Progress; Active-Closeout; Inactive-Returned, and Closed Completed.

4. The method of claim 1, further comprising providing a dashboard module including summary column headings and including sort and filter functionality, wherein column headings include at least one of: client name, department name, grant program name, project name, status, total grant amount awarded, local match, in-kind, and total project amount.

5. The method of claim 1, further comprising providing a grant sub-module adapted to collect information including at least one of: catalog of federal domestic assistance number; performance period; grant award date; grant final close out date; pre-award authority notation and effective date; audit dates; allowance to extend performance period; and records retention expiration date.

6. The method of claim 1, further comprising providing a project module including sub-modules that enable users to input critical information about a project or program and enables user to manage the project or program throughout a performance period for the project or program.

7. The system of claim 6, further comprising a notes module adapted to allow users to enter notes and provide or share communications with other authorized users, wherein notes can be archived in association with a particular project.

8. A method for managing grants and projects, comprising:
providing a grant and project management and administration system enabling authenticated multiple party secured remote access to users via an Internet portal and including a dashboard module, a grant management module, a project management module, and a database storing documents and information related to grants, projects, users, and budgets;
accessing the dashboard module via the Internet portal and assigning user roles and user names to at least one of a grant award and a project and authorizing user access to the grant and project management and administration system and data associated with the at least one of a grant award and a project based on a determined level of need for access by authorized users;
accessing the grant module via the Internet portal and entering unique information necessary to manage at least one of a grant, said unique information including at least one of: source of funds by name and identification number; performance period with set parameters to enable verification checks to assure scheduled tasks remain within the performance period; final close out date; extensions; pre-award authority identification; audit history; record retention period information; and
accessing the project management module via the Internet portal and entering unique information necessary to manage a project associated with the grant, said unique information including at least one of: project name, project location, an identification of team members assigned to the project; project tasks, scheduling, deadlines;
wherein information entered in the dashboard module, the grant module and the project management module are stored in the database for ongoing access by the authorized users.

9. The method of claim 8, wherein the determined level of need for access by the authorized users enables the authorized users with at least one of: full access, data entry access, report generation, view only.

10. The method of claim 8, further comprising the step of accessing a finance module via the Internet portal and enabling an authorized user to engaged in at least one of: entering an approved budget, track active requests for reimbursements, show a historical tracking of requested and approved amendments, show a historical tracking of requests for reimbursements, confirm funds that are received, track retainage by a funding agency, and provide a summary snapshot of key grant or project information.

11. The method of claim 8, further comprising the step of accessing a compliance checklist via the Internet portal and enabling an authorized user with access to at least one of: a compilation of major compliance requirements from grant contracts, state laws and regulations, federal laws and regulations, OMB Circulars, Executive Orders; entry of the law/regulation/rule; special notes; identification of a person on the team who is responsible for compliance; audit records.

12. The system of claim 8, further comprising a notes module adapted to allow users to enter notes and provide or share communications with other authorized users, wherein notes can be archived in association with a particular project.

13. A system for managing grants and associated projects, comprising:
a grant and project management and administration system enabling authenticated multiple party secured remote access to users via an Internet portal;
a dashboard module,
a grant/loan management module,
a project management module, and
a database storing documents and information related to grants, projects, users, and budgets.

14. The system of claim 13, wherein the dashboard module, the grant loan module and the project management module and database interoperate in order to fulfill a user data information request or the reporting of new information from/to the grant and project management and administration system by users via a user device.

15. The system of claim 13, further comprising an agency module configured for entry of organizational information including at least one of client name, contact, contracts, documents.

16. The system of claim 15, wherein the agency module, dashboard module, the grant loan module and the project management module and database interoperate in order to fulfill a user data information request or the reporting of new information from/to the grant and project management and administration system by users via a user device.

17. The system of claim 13, further comprising a report module configured for generating reports accessible by authorized users including auditors, said reports including at least one of: documents relevant to particular tasks requested through the grant and project management and administration system, audit documents, metrics information, schedule information, notes, documents fulfilling a search criteria, documents fulfilling a format criteria.

18. The system of claim 17, wherein the report module, dashboard module, the grant loan module and the project management module and database interoperate in order to fulfill a user data information request or the reporting of new information from/to the grant and project management and administration system by users via a user device.

19. The system of claim 13, wherein said grant module further comprises audit tab feature adapted to store documents typically required for an audit.

20. The system of claim 19, wherein the includes portal access for auditors thereby providing the auditors with access to the audit tab and streamlined access to the documents typically required for an audit.

21. The system of claim 13, further comprising a project schedule module configured to incorporates project and grant scheduling information into reports.

22. The system of claim 13, further comprising a project team sub-module adapted to integrate with the project schedule module and allow authenticated users to assign schedule tasks, which in turn generates auto-generated email alerts based on parameters configured via the portal in the project management module.

23. The system of claim 13, further comprising a notes module adapted to allow users to enter notes and provide or share communications with other authorized users, wherein notes can be archived in association with a particular project.
